(19) United States
(12) Patent Application Publication
(10) Pub. No.: US 2011/0297522 A1
(43) Pub. Date: Dec. 8, 2011

(54) Motion controlled light switch control device

(76) Inventor: Ihab H. Elzing, San Jose, CA (US)

(21) Appl. No.: 13/134,227

(22) Filed: Jun. 1, 2011

Related U.S. Application Data
(60) Provisional application No. 61/350,182, filed on Jun. 1, 2010.

(51) Int. Cl. H01H 43/02

(52) U.S. Cl. 200/33 D

(57) ABSTRACT

In accordance with one embodiment a device that fits and installs on top of a light switch comprising of:

A Base plate holding a motor, a battery pack, a gear on the motor driving a rack with a gliding hammer arm connected to as part of the rack, which moves along with the rack when the motor gear turns in either direction along a guiding channel with a mechanical or a magnetic reed switch actuated by the rack pushing it or magnetically activating it using a reed switch and a magnet placed on the rack or the hammer in order to turn the device on and off with a motion sensor an audio alert device, an audio input device “microphone and a LED indicator. Accordingly several advantages in a number of aspects are as follow: The rack and gear approach eliminates complicated gear box which is both noisy and difficult to manually override. The hammer approach allows for the turn on and off of the light switch as light switch is normally used. The audio alert device alerts occupants the lights will be shut off and also accepts audio input such as clapping whistling or talking to abandon the lights shut off action if there is audio activity from the occupant.

### CROSS REFERENCE TO RELATED APPLICATION

This application claims the benefit of the provisional application Ser. No. 61/350,182, Filed 1 Jun. 2010 by the present inventor EFS ID: 7720180.

### BACKGROUND

### Prior Art

The following is prior art that presently appears relevant:

| Publication Number. | Kind code | Pub. Date | Applicant |
|---|---|---|---|
| US20080202909 | A1 | Aug. 28, 2008 | Michael L. Agronin |

### BACKGROUND

Electronic light switches in the market tend to have a number of limitations. The most common limitations are professional install no self-install. They shut off the lights without warning and you cannot once installed manually control the light switch. The prior art cited in this application does away with some of the limitations such as professional install because it's self-installable. However it has a number of drawbacks such as use of gears and levers which is noisy, manual override is difficult and no warning mechanism in place. The usage of gears and levers makes the turn on and off time quiet long as 10 seconds this makes it non practical to enter a room and wait 10 seconds for the lights to turn on.

### SUMMARY

In accordance with one embodiment a A device that fits and installs on top of a light switch comprising of:

A Base plate holding a motor, a battery pack, a gear on the motor driving a rack with a gliding hammer arm connected to as part of the rack, which moves along with the rack when the motor gear turns in either direction along a guiding channel with a mechanical or a magnetic reed switch actuated by the rack pushing it or magnetically activating it using a reed switch and a magnet placed on the rack or the hammer in order to turn the device on and off with a motion sensor an audio alert device, an audio input device “microphone and a LED indicator.

### Advantages

Accordingly several advantages in a number of aspects are as follow: The rack and gear approach eliminates complicated gear box which is both noisy and difficult to manually override. The hammer approach allows for the turn on and off of the light switch as light switch is normally used. The audio alert device alerts occupants the lights will be shut off and also accepts audio input such as clapping whistling or talking to abandon the lights shut off action if there is audio activity from the occupant. Additional advantages will be more apparent from the ensuing description.

### DRAWINGS

### Figures

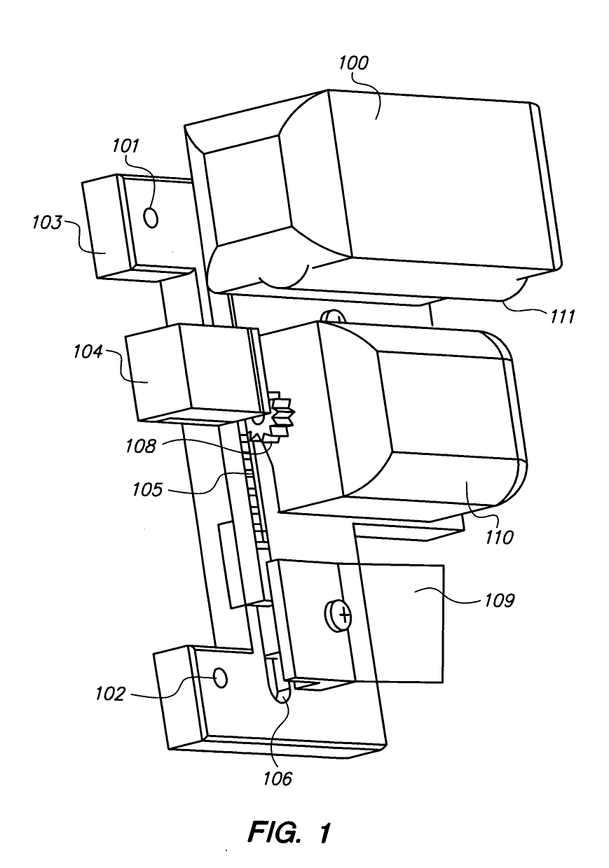

FIG. 1 shows internals of light switch control device.

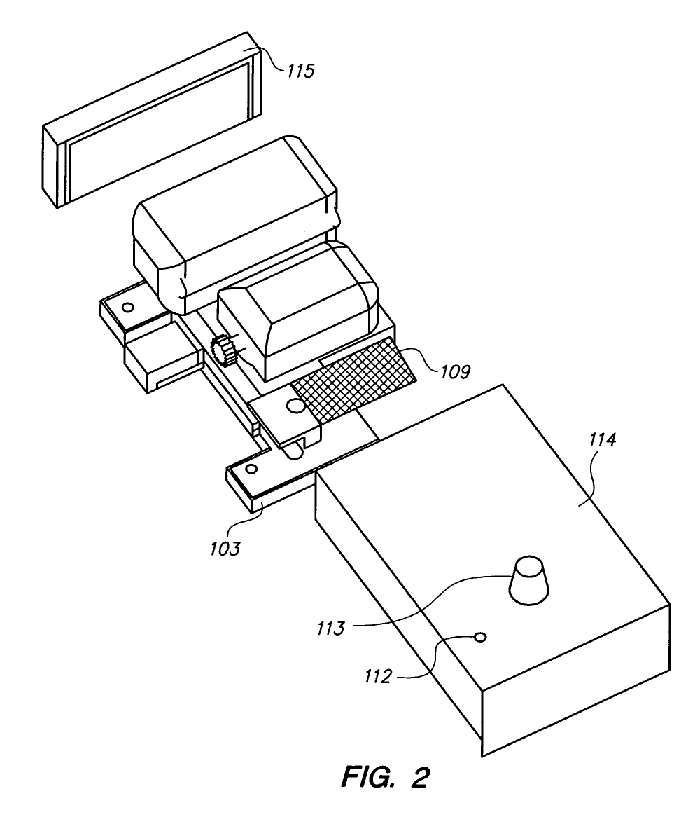

FIG. 2 shows the exterior and interior pieces that make up the light switch control device.

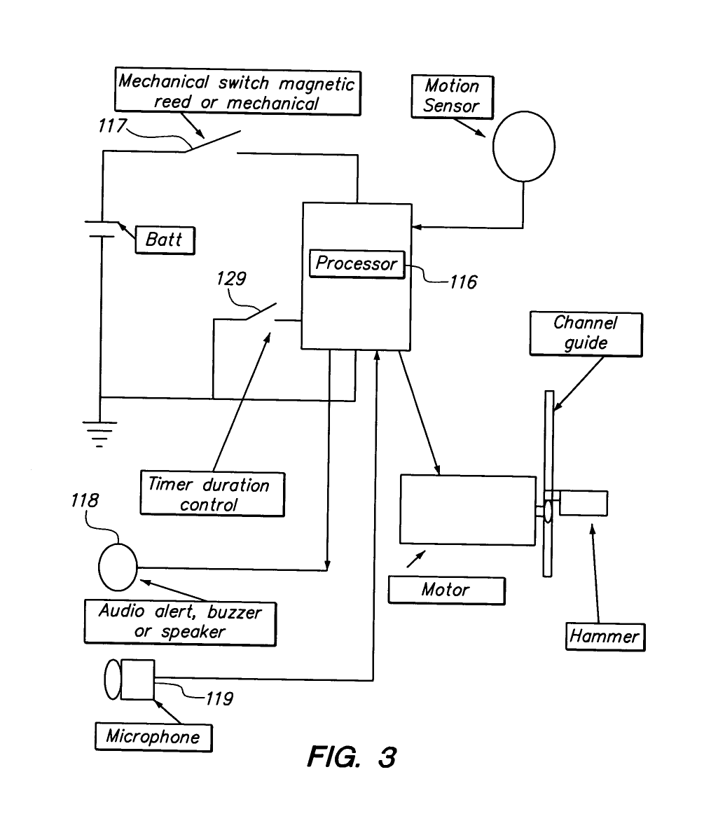

FIG. 3 shows the circuit block diagram that controls the light switch control device.

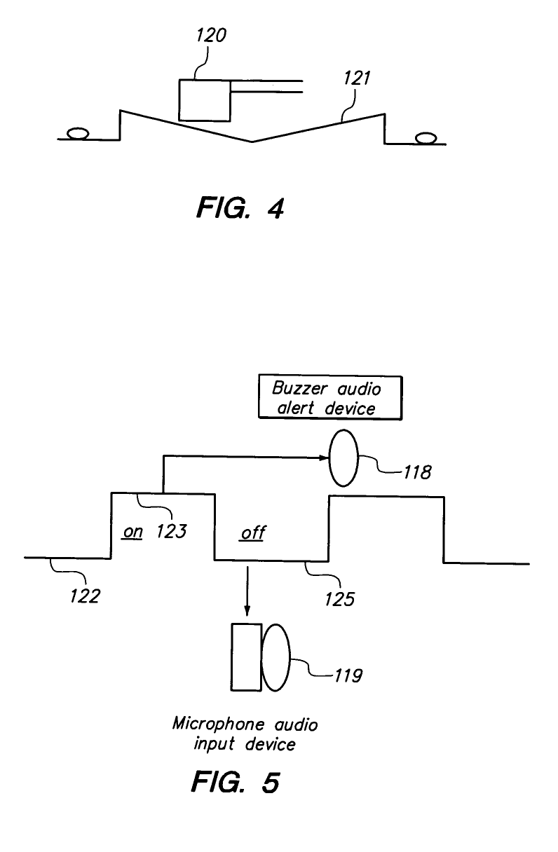

FIG. 4 shows a different type of a hammerhead to control a flat type light switch.

FIG. 5 shows the audio mechanism control signal.

Drawings - Reference Numerals

| | |
|---|---|
| 100 battery pack | 101 mounting hole |
| 102 mounting hole | 103 base plate |
| 104 hammer | 105 rack |
| 106 channel groove | 108 gear |
| 109 control circuit board | 110 motor |
| 111 batteries | 112 LED |
| 113 Motion sensor module | 114 cover |
| 115 Battery cover | 116 processor |
| 117 mechanical/magnetic reed | 118 Audio alert device |
| 119 Audio input device Microphone shape | 120 A different hammer |
| 121 a flat wall switch signal | 122 Audio drive control |
| 123 on time of the audio control signal | 125 off time of the audio |
| control signal | |
| 129 time duration interval switch | |

### DETAILED DESCRIPTION

The device described in this embodiment shown in FIG. 2 is an electromechanical device that senses motion and decides to turn off the lights based on not detecting motion for a given amount of time.

The device goes on top of a standard wall light switch, it does not replace it, but it goes on top of it.

The device utilizes a motion sensor 113 shown in FIG. 2. The device internals are shown in FIG. 1, The device has two screw holes 101 and 102 that are used to fasten its base plate 103 to a standard light switch wall plate like the ones found in ordinary homes.

The unit also has a motor 110 with a gear 108 that moves a rack 105 shown in FIG. 1.

The rack 105 in FIG. 1 is attached to a gliding hammer 104.

The gliding hammer 104 slide in a groove guide channel 106 that is smooth enough for minimum friction shown in FIG. 1.

The device uses a battery holder 100 shown in FIG. 1 to power up the unit, only when the light switch is turned to the on position.

The unit is completely off when the light switch is off to further save battery life, other wise the unit turns the lights off and it will never turn the lights on.

The device uses a gliding hammer mechanism 104 Shown in FIG. 1 to force the toggle switch on the light switch to move from one position to another.

The gliding hammer 104 is made to strike the toggle switch at its tip to maximize the force applied to the toggle switch.

The device is mounted on a light switch wall plate using the same fastening screws originally on the wall plate as shown in FIG. 1 using the mounting holes 101 and 102.

The device is turned on when the light switch is toggled, this done mechanically using a magnetic reed relay or a mechanical switch 117 attached to the hammer mechanism 104 FIG. 1 and FIG. 3.

Once the switch connects the battery pack 100 to the circuit board 109 a microcontroller IC 116 shown in FIG. 3, starts a timer and monitors the motion sensor 113 for no motion. If motion is detected the timer is reset and counts down again and so on. If no motion is detected the counter counts down and until it expires and then turn the motor 110 on to push the rack 105 which in turn pushes the hammer in the gliding channel 106 shown in FIG. 1 to strike the toggle switch and shut the light switch off. The unit also incorporates a time duration switch 129 which allows a short time interval for normal operation lets say 5 minutes and a long term time interval in case a longer time duration is required.

The unit also incorporates a audio alert mechanism 118 in the form of buzzer or speaker to alert the any person in the room its about to shut sown before it actually shuts down.

In response to the audio alert the unit have a microphone 119 if the person in the room Hears the audio alert and does not want the lights to turn off he can make a sound, whistle or clap to restart the timer and prevent the unit from turning the lights off. The unit will also generate the audio alert using audio alert device 118 during on time 123 in a time oscillating fashion 122 on and off as shown in FIG. 5. During the off time 125 it will listen to incoming audio signals from microphone 119 to decide to shut the light off or restart the timer and stay on.

The use of the off time 125 is very important because it allows the device to listen using microphone 119 while not impaired by its own audio alert device 118.

The unit utilizes different shapes of gliding hammers 120 to adapt to different light switch types, as the ones shown in FIG. 5, where it is adapted to toggle on a flat light switch 121 shown in FIG. 4.

The unit also includes a cover 114 shown in FIG. 2 to cover and protect its internals a base plate 103 to hold its internal parts and a battery cover 115 to allow end users to replace the batteries.

I claim:

1. A device that fits and installs on top of a light switch shown in FIGS. 1 and 2, comprising of:
A Base plate holding a motor, a battery pack, a gear on the motor driving a rack secured in a grooved channel.
A gliding hammer arm connected to or a part of the rack, which moves along with the rack when the motor gear turns in either direction along a guiding channel similar to the ones shown in FIG. 1.
A mechanical or a magnetic reed switch actuated by the rack pushing it or magnetically activating it using a reed switch and a magnet placed on the rack, or the hammer in order to turn the device on and off shown in FIG. 13.
A motion sensor shown in FIG. 2.
Selectable time duration switch.
An audio alert device.
An audio input device “microphone”.
A LED indicator.

2. The device of claim 1 where the tip of the gliding hammer strikes a standard light switch at the tip of it to maximize the force applied to its toggle switch.

3. The device of claim 1 where the hammer hits a flat light switch using the bottom portion of the hammer as shown in FIG. 4.

4. The device of claim 1 where it is modular and can accept different gliding hammers with different hammer shapes to accommodate different switch types.

5. The device of claim 1 where it uses a gear motor controls a rack to move a hammer along a guide channel.

6. The device of claim 1 and also applies to any device that controls light sources where it will issue an audio alert for some time before it actually shuts off the light source to alert anyone that the lights will be shut off.

7. The device of claim 1 and also applies to any device that controls light sources where it will accept an audio signal such as talking whistling or clapping to prevent it from shutting the lights off.

8. The device of claim 1, claim 6 and claim 7 where it will generate an audio alert repeatedly on and off for a period of time on and a period of time off. During the off time it will listen for any sound of claim 7 to prevent it from shutting the light off.

9. The device of claim 1 where a magnetic reed switch is used to turn the device on.

10. The device of claim 1 where a mechanical switch is used to turn the device on.

11. The device of claim 1 where a mechanical switch or a magnetic reed switch is used to turn the device on or off based on the position of the rack or any mechanical part attached directly or indirectly to the rack.

12. The device of claim 1 where it will use an LED to indicate it's about to turn off the light source “light switch”.

13. The device of claim 1 and also applies to all light control devices that are battery operated to use an LED to indicate a battery low status.

14. The device of claim 1 where once the device is on will start a countdown timer to shut turn the motor on to shut the lights off.

15. The device of claim 13 where the timer will be reset and start counting down from the beginning again if motion is detected.

16. The device of claims 1 and 10 where the device will be shut off when the mechanical switch is not pressed on by the rack or any assembly attached to the rack.

17. The device of claims 1 and 10 where the device will be shut off when a magnetic reed switch is not enabled by a magnet connected to the rack assembly.
